(19) United States
(12) Patent Application Publication
(10) Pub. No.: US 2026/0021020 A1
(43) Pub. Date: Jan. 22, 2026

(54) Pill Dispenser and Organizer

(71) Applicant: Matthew Zusy, North Royalton, OH (US)

(72) Inventor: Matthew Zusy, North Royalton, OH (US)

(21) Appl. No.: 19/273,069

(22) Filed: Jul. 17, 2025

Related U.S. Application Data
(60) Provisional application No. 63/672,671, filed on Jul. 17, 2024.

(51) Int. Cl. A61J 7/00

(52) U.S. Cl. CPC A61J 7/0076

(57) ABSTRACT

A dispenser for pills includes a base member, a top surface, a coupling member, and a retrieval area. The base member is for seating on a surface and has a substantially centrally located through opening in the interior thereof, with a chute extending outwardly therefrom. A top surface is associated with the base member and in communication with the through opening and the chute. The coupling member is attached to the base member adjacent the top surface thereof and has a coupling mechanism positioned therein for mating with an end of a receptacle. The retrieval area is coupled to an outer end of the chute. The coupling member is movable to tighten the receptacle against the top surface.

### CROSS-REFERENCE TO RELATED APPLICATION

The present application claims priority to U.S. Provisional Application No. 63/672,671, filed on Jul. 17, 2024, the disclosure of which is incorporated herein by reference in its entirety.

### FIELD

The invention relates to a pill dispenser designed to facilitate the retrieval of items such as supplements, vitamins, or medications in pill form from a container, such as a bottle in an inverted orientation.

### BACKGROUND

Traditional pill bottles often require users to pour out pills, risking spillage or contamination. One current product requires the user to fill dispensers every week or two. There are also large dispensers that can store two or more different types of pills. These dispensers need to be labeled to keep track of the pill type because different pills can have a similar appearance and are not usually labeled.

### SUMMARY

A dispenser for dispensing the contents of a bottle includes a base member having an opening into the interior thereof. A coupling mechanism is coupled to a top surface of the dispenser for holding a bottle inside the dispenser. The bottle deposits contents into the interior of the dispenser so that contents may be removed from the dispenser.

### BRIEF DESCRIPTION OF THE DRAWINGS

FIG. 1 is a perspective view of a dispenser according to the invention with an attached pill bottle;

FIG. 2 is a side cross-sectional view of the dispenser of FIG. 1;

FIG. 3 is an expanded perspective view the dispenser before attaching to a pill bottle;

FIG. 4 is a perspective view of the dispenser in an inverted position during which a bottle can be installed on the dispenser;

FIG. 5 is a perspective view of the dispenser with an attached separate pill bottle showing a pill retrieval door in an open position;

FIG. 6 is a cross-sectional view of the dispenser of FIG. 5;

FIG. 7 is a perspective view of the dispenser before having a separate bottle installed in the dispenser;

FIG. 8 is a side view of the dispenser with a pill bottle installed in the dispenser;

FIG. 9 is an exploded perspective view of the dispenser of FIG. 1;

FIG. 10 is a cross-sectional top view of a coupling mechanism of the dispenser of FIG. 1 with a bottle installed in the coupling mechanism, the bottle being clamped down upon by the coupling mechanism and being of a first size;

FIG. 11 is a cross-sectional view of the coupling mechanism of the dispenser of FIG. 11 without a bottle installed in the coupling mechanism;

FIG. 12 is a cross-sectional view of the coupling mechanism of the dispenser of FIG. 1 with a bottle installed in the coupling mechanism, the bottle being clamped down upon by the coupling mechanism and being smaller in diameter than the bottle shown in FIG. 10;

FIG. 13A depicts a first embodiment of a means for coupling in the form of rachet humps coupled to a cam follower/pawl for coupling the bottle to the coupling mechanism;

FIG. 13B is a second embodiment of a means for coupling in the form of a friction device used to couple the bottle to the dispenser;

FIG. 14 is a cross-sectional enlarged view of the connection between a bottle and the coupling mechanism, showing a seal added between the bottom of the bottle and the top surface of the base of the dispenser;

FIGS. 15A-15B depict alternative embodiments showing enlarged views of grasping mechanisms for coupling the coupling mechanism to the bottle;

FIG. 16 depicts an arm of the coupling mechanism in a first clamping position where it clamps down on a bottle;

FIG. 17 depicts an arm of the coupling mechanism in a second open position showing the arm retracted;

FIG. 18 depicts a bottom plan view of the coupling mechanism of the dispenser;

FIG. 19 depicts a perspective bottom view of the coupling mechanism of the dispenser;

FIG. 20 illustrates two dispensers positioned adjacent to one another prior to being coupled together with a mechanical fastener;

FIG. 21 is an exploded view of part of the dispensers shown in FIG. 20 showing the connecting fasteners of FIG. 20;

FIG. 22 depicts multiple dispensers being coupled together;

FIG. 23 depicts an interior bottom view of two dispensers connected together with a mechanical fastener;

FIG. 24 depicts a coupling mechanism of the dispenser like that shown in FIG. 12 but with two arms instead of three arms;

FIG. 25 depicts a coupling mechanism of the dispenser like that shown in FIG. 12 but with four arms instead of three arms;

FIG. 26A depicts an alternative means for coupling using differently shaped arms for clamping down on the bottle, with the arms in an open position;

FIG. 26B depicts the embodiment of FIG. 26A with the arms in a clamping position;

FIG. 27 depicts a perspective view of another embodiment of the invention where the pill bottle is screwed into the dispenser instead of having a coupling mechanism;

FIG. 28 is a cross-sectional side view of the dispenser with the bottle shown in FIG. 27 installed;

FIG. 29 is a cross-sectional side view of the dispenser showing a desiccant chamber positioned under the chute of the dispenser, with a desiccant bag installed in the chamber; and

FIG. 30 depicts an exploded perspective bottom view of the embodiment shown in FIG. 29.

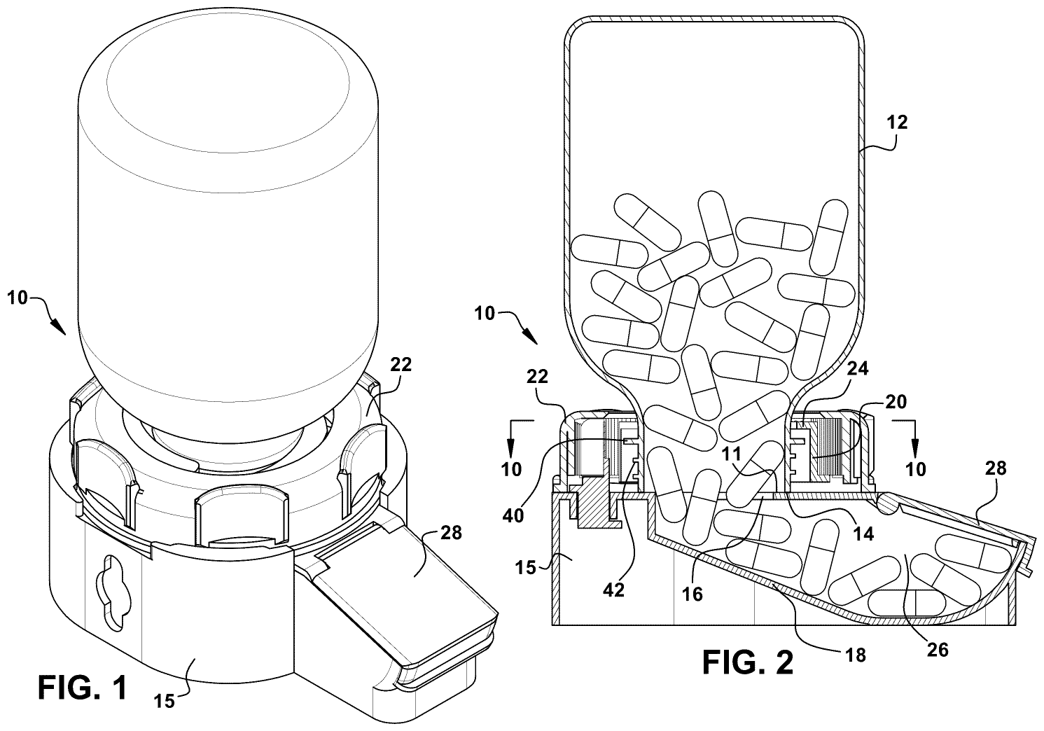

### DETAILED DESCRIPTION

The present invention addresses the issues noted above by providing a dispenser that securely attaches to an inverted bottle, allowing for controlled dispensing and easy one-handed retrieval of pills. With the present invention, the pills always stay with the bottle they came in.

A dispenser is disclosed herein that attaches to a bottle in an inverted orientation, allowing pills to fall through a central hole and into a retrieval area for user access. Key features of the dispenser include an attachment mechanism, a moisture-proof seal, a chute and retrieval area, one-handed operation, adjustable clamping, friction and securing means, an expandable configuration, and a safety feature.

In terms of the attachment mechanism, the dispenser clamps onto the neck of a capless bottle. This secures the bottle in an inverted position. The clamping mechanism includes a dial and clamping arms that apply forces to the bottle neck. A moisture-proof seal is formed at the top surface of the dispenser. The top surface of the dispenser forms a seal with the inverted bottle, which prevents the ingress of moisture, ensuring the pills remain dry inside the bottle.

The dispenser 10 has a chute and a retrieval area. Pill fall through a central hole in the dispenser's top surface and are directed via the chute to the retrieval area. A door is provided for controlled access to the retrieval area. Users can open the door and retrieve pills using one hand, enhancing convenience to the user.

The dispenser 10 includes adjustable clamping in the form of a tightening dial with a cam mechanism that adjusts clamping force on the bottle. This permits the device to adjust for different sized bottle. Rotation in one direction increases clamping pressure. Rotation can occur in either the clockwise or counter-clockwise direction. The tightening dial has a humped cam surface that interacts with clamping arms, which provides friction to prevent unintentional loosening. Upwardly extending ledges on the arms secure the bottle against separation.

The dispenser 10 is expandable so that multiple dispensers can be coupled together. Male and female connectors on the sides of the dispenser allow for multiple dispensers to be linked, facilitating grouping of different pill bottles. The dispenser provides a safety feature by keeping the pills in their original bottles, which reduces the risk of mixing up medications. This enhances safety compared to traditional pill dispensers. Also, the pills can be accessed on a shelf or in a cabinet, without the need to take them from the shelf or cabinet, where they stay out of the reach of children.

Advantageously, pills essentially never leave the bottle they are purchased in and are mounted on a dispensing stand. This dispensing stand could be provided by a pharmacy along with the pill bottle, for example, to make dispensing easier.

Referring to the Figures, the dispenser 10 includes three primary components: the top surface 11, a clamping mechanism 22, and a retrieval area 26 and base 15. The top surface 11 of the dispenser 10 is the part of the device that interfaces with a medication bottle 12. In particular, the top surface 11 of the base 15 interfaces with the bottle's 12 rim 14 to form a moisture-proof seal. A central hole 16 in the top surface permits pills to pass through the dispenser top surface 11 into the chute 18.

The dispenser 10 includes a clamping mechanism that has three clamping arms 20. The clamping arms 20 are controlled by a tightening dial 22 and serve to secure the bottle 12 in place. The tightening dial 22 includes a cam mechanism that adjusts the clamping force on the medication bottle 12, and extending ledges 24 on the arms hold the bottle 12 securely in position on the top surface 11 of the dispenser 10.

The dispenser 10 has a retrieval area 26. Pills are directed from the central hole 16, through a chute 18 into the retrieval area 26, which is positioned behind a door 28. The retrieval area 26 is designed for one-handed access, allowing users to easily remove pills from the dispenser.

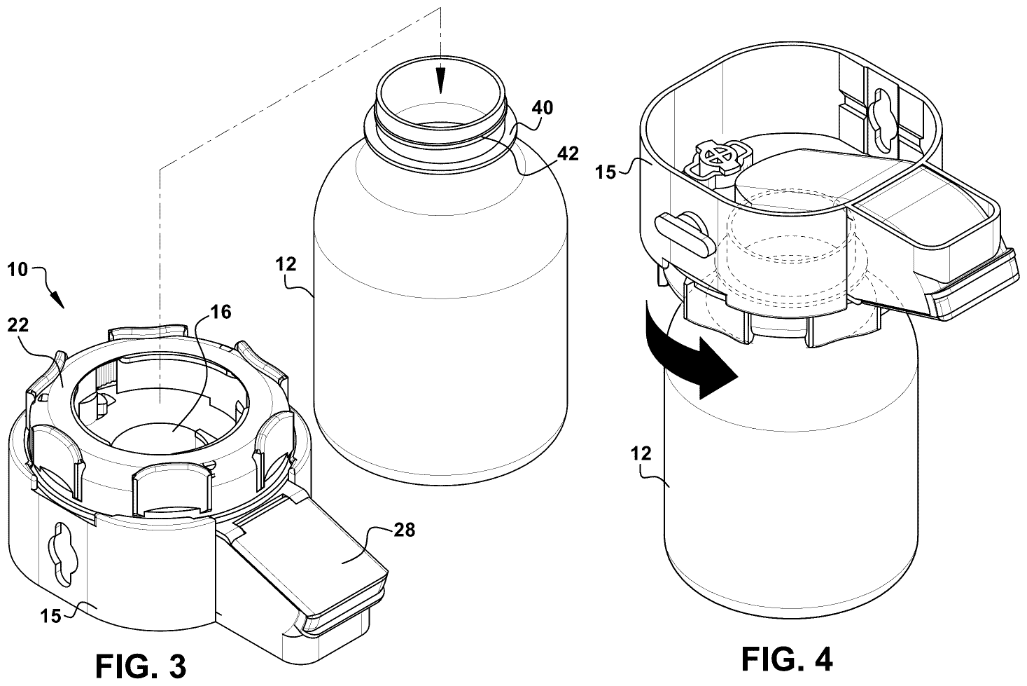

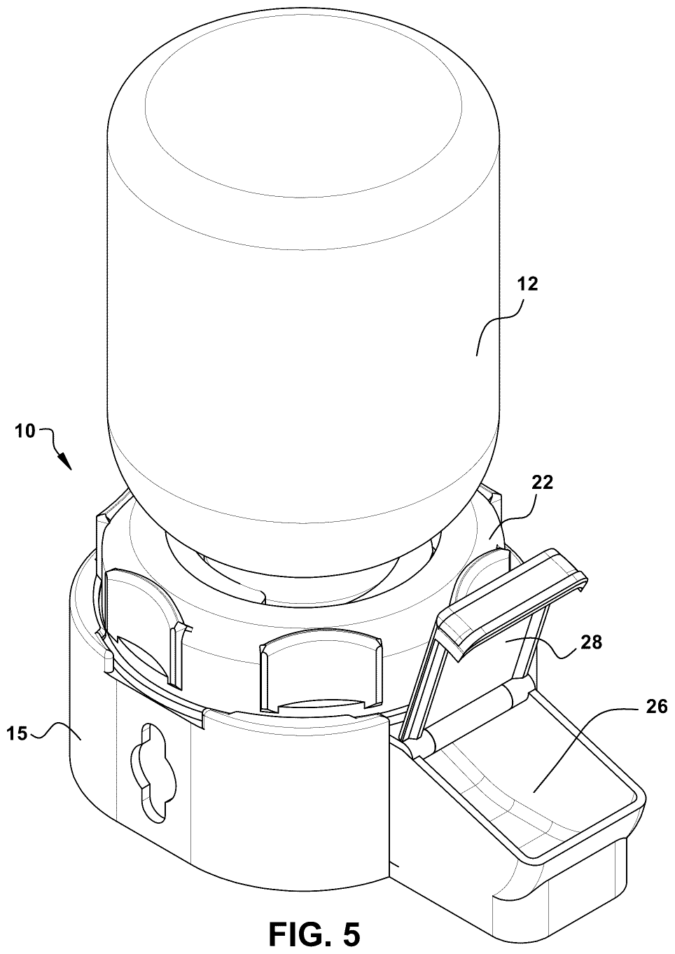

FIGS. 3-5 describe the operation of the dispenser 10. In FIG. 3, the dispenser is shown in an inverted orientation with the on top of an opened medication bottle 12. FIG. 4 illustrates the process of locking the bottle in position on the dispenser by turning the dial 22. Once locked as shown in FIG. 5, the bottle and dispenser 10 are flipped, allowing pills to fall through the hole 16 and down the chute 18 to the retrieval area 26, which can be accessed by opening the door 28.

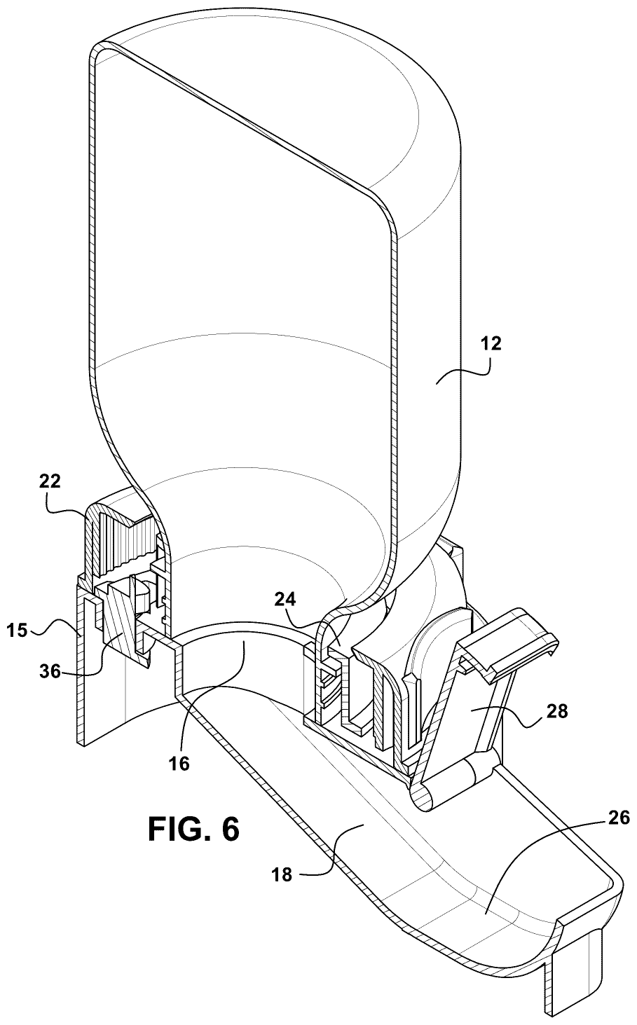

FIG. 6 depicts a cross-sectional side view of a bottle 12 coupled to the dispenser showing the opening in the top surface positioned below the bottle, with the bottle resting on the top surface 11. FIG. 6 also shows details of the clamping mechanism and how the clamping mechanism arms clamp down over a ledge or the screw threads of the bottle to hold it down against the top surface 11 of the dispenser. The connection between the top surface and the top end of the bottle 12 is facilitated by the clamping mechanism, which presses down against a ridge on the bottle 12 so that a substantially airtight seal is created between the top end of the bottle 12 and the top surface 11.

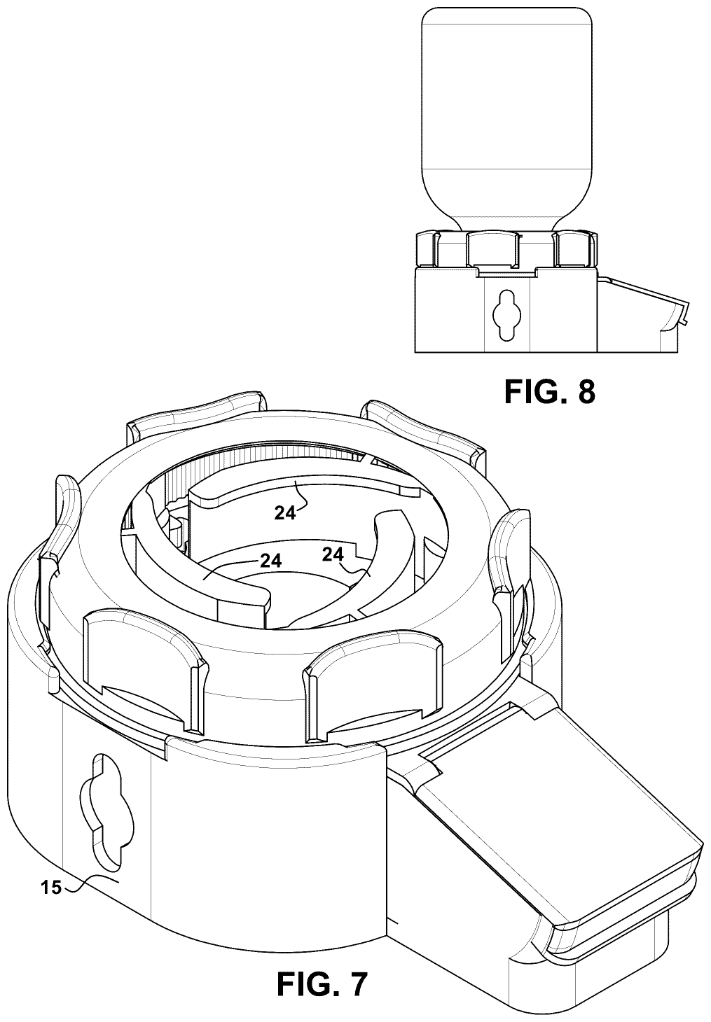

FIG. 7 depicts the dispenser without a bottle installed in the clamping mechanism. It also shows an opening positioned in the side of the dispenser for coupling with other dispensers. As is evident, the clamping mechanism has arms 20 that are used to clamp around a bottle having a ledge or screw threads to trap the bottle in position. FIG. 8 is a side view of the device 10 with a bottle 12 installed thereon showing a plan view of the side of the device 10.

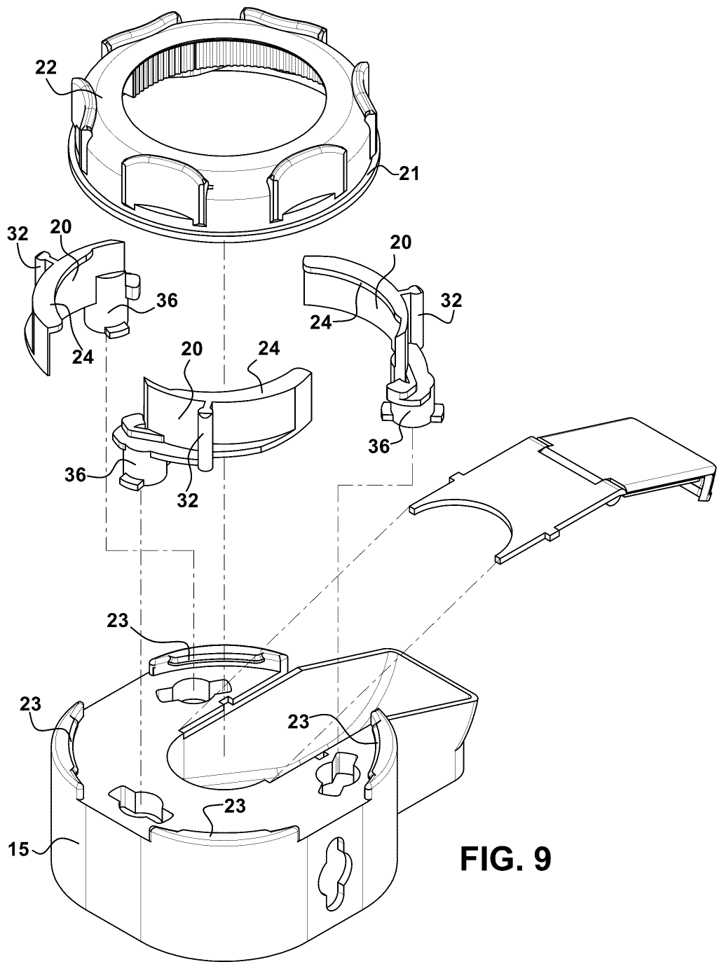

FIG. 9 depicts the clamping mechanism in an exploded view. The clamping mechanism includes a dial 22 that is free to rotate but is fixed relative to the base by four overhanging ledges 23 that trap the dial 22 at its flange 21.

FIG. 8 is a side view of the device 10 with a bottle 12 installed thereon showing a plan view of the side of the device 101. FIG. 9 also shows how the door 28 seats over the retrieval area 26. The door 28 includes protrusions that seat in slots defined in the base 15 to hold the door 28 in position. The door 28 includes a hinge between the rear end of the door and the front end of the door. The hinge permits the door 28 to bend in a middle area so that the door 28 substantially matches the shape of the base 15.

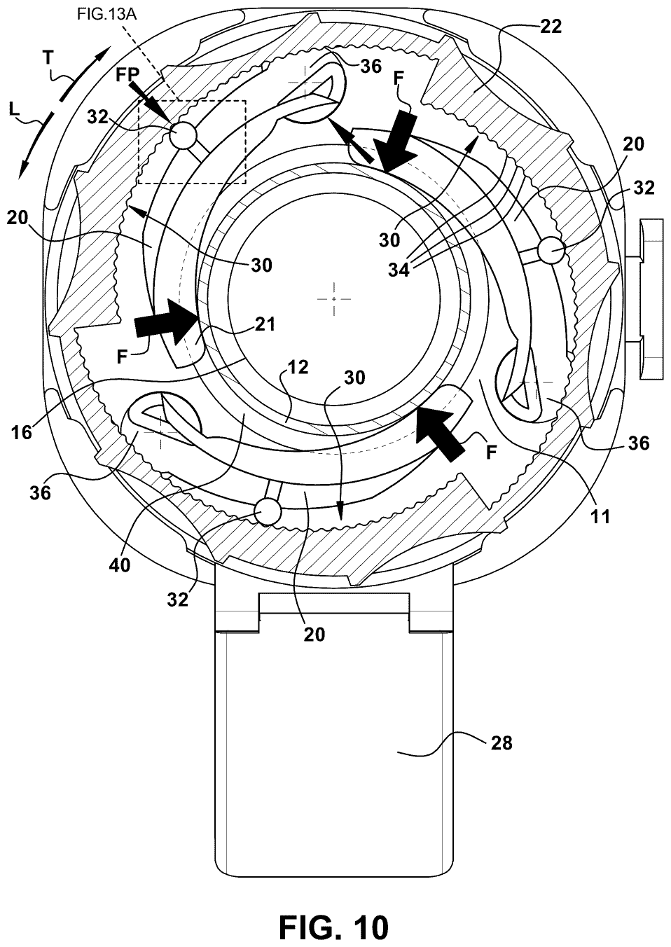

FIGS. 10, 11, 12, 13A, and 13B depict the bottle clamping mechanism. The bottle clamping mechanism seats on top of the base 15 and is coupled to the base 15 via openings that are positioned in an upper surface of the base. These openings mate with downwardly extending appendages having an axle 36, that seat in the openings and are rotatable in the openings. The dial 22 has indents spaced around the sides of the dial 22, which are used to aid in gripping the dial 22. When the dial 22 is rotated clockwise (from the viewpoint facing the top surface 11), as depicted in FIG. 10, the cam surface 30 applies force to the arm 20. On the arm 20, the cam follower 32 works as a pawl sliding over spaced protruding rounded ratchets or humps 34 on the cam surface 30. The cam follower may be spring-loaded. This action causes the arm 20 to pivot about its axle 36, which extends into the base 15. Each arm 20 applies force F to the bottle 12, centering the bottle opening with the surface hole. The ledges 24 on each arm 20 extend over the bottle flange 40 or bottle threads 42, preventing the bottle from being pulled out.

The force F on the bottle increases as the dial 22 is rotated in the clockwise direction. Each arm flexes under the strain of this force. The bottle may flex as well. When a desired bottle holding force is reached, the user stops turning the dial.

FIG. 10 shows how less force is needed to release the medicine bottle 12 than is required to lock/tighten the bottle 12 into position. When a force FP is applied to the pawl 32 of arm 20, it induces a strain on the arm 20. This strain is experienced between the axle 36 and the area of the arm 21 that makes contact with the bottle 12. The dial 22 is designed to resist rotation due to the positioning of the cam follower/pawl 32 between two humps 34 on its path and strained flexing of the arm 20 which maintains the outward force of the pawl 32 on the cam surface 30. These humps act as barriers that the pawl 32 must overcome to allow the dial 22 to rotate.

The dial 22 has a release mechanism that permits the bottle 12 to be released from the base 15. To release the bottle, the dial 22 is turned counterclockwise. As the dial begins to rotate, the pawl 32 must overcome the initial hump 34. This initial hump requires a slightly greater force due to the additional bending strain imposed on the arms 20. The strain is a result of the pawl 32 pushing against the hump, causing the arm 20 to flex further.

Once the pawl 32 passes the initial hump, the next hump 34 is positioned radially further from the center of the dial. At this point, the arm 20 is still in a state of bent strain. As the dial continues to turn, the pawl 32 encounters this next hump with reduced resistance because the arm 20 is still flexed. Consequently, less rotational force is required to move the pawl 32 past this hump.

As the cam follower/pawl 32 progresses past each successive hump, the resistance encountered diminishes. This is due to the flexing behavior of arm 20, which, after being strained, takes some time to reset to a less flexed state. This temporary flexed state facilitates easier passage of the pawl 32 over subsequent humps with less rotational resistance. This ensures that the dial 22 can be easily rotated to release the bottle, enhancing the efficiency and usability of the device.

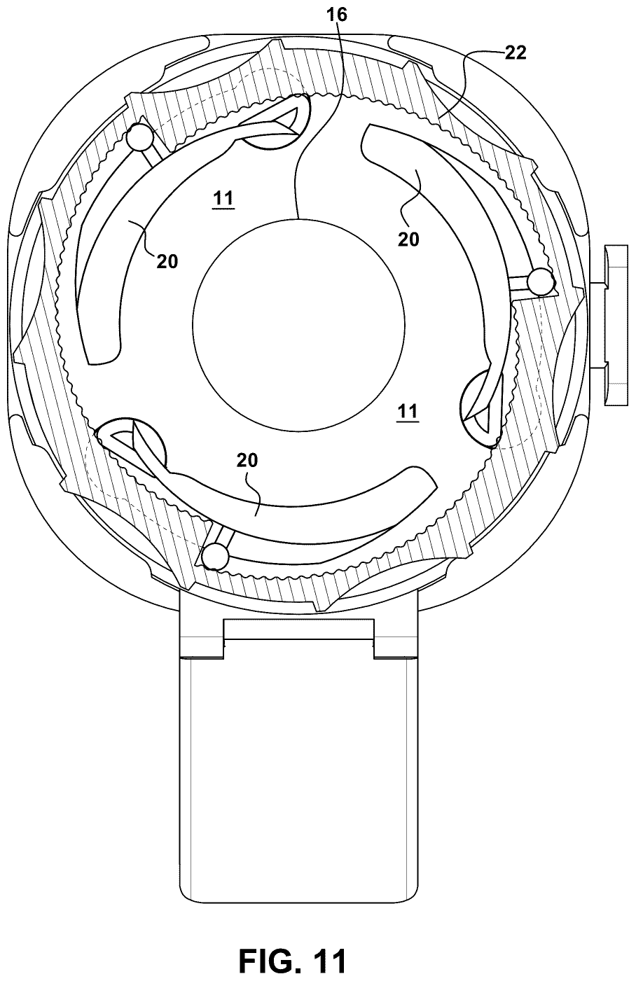

FIG. 11 shows the arms 20 fully retracted for loading a bottle into the clamping mechanism. As is evident the top surface 11 has a fixed sized opening. A bottle 12 for seating in the device 10 should have an opening that is greater than the diameter of the opening of the top surface 11. Bottles that are larger than the size of the opening may be utilized and bottles having substantially the same size as the opening may be utilized. The size of the opening can be changed to seat bottles 12 having a smaller diameter opening, if desired.

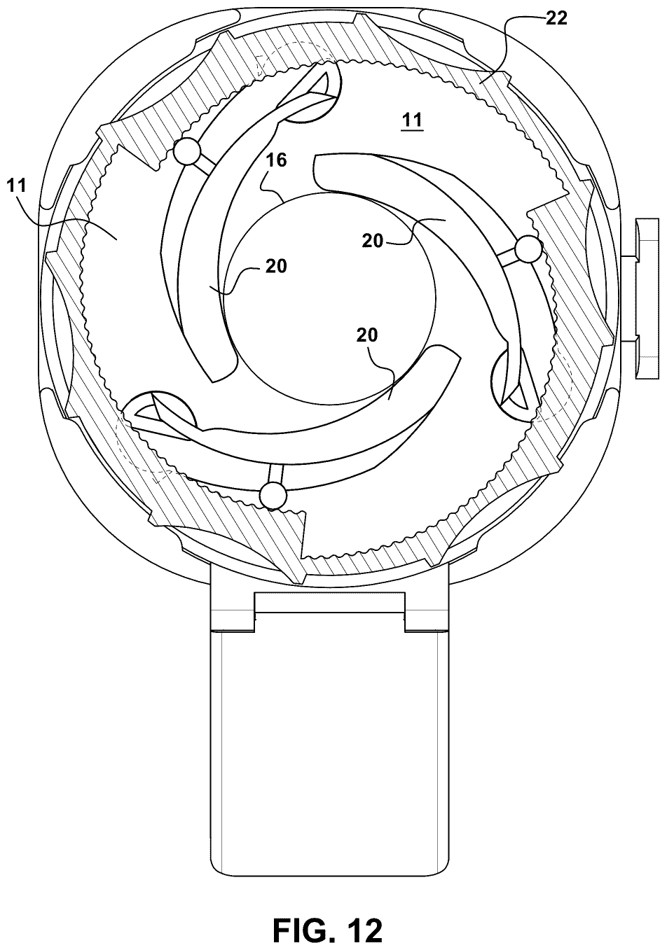

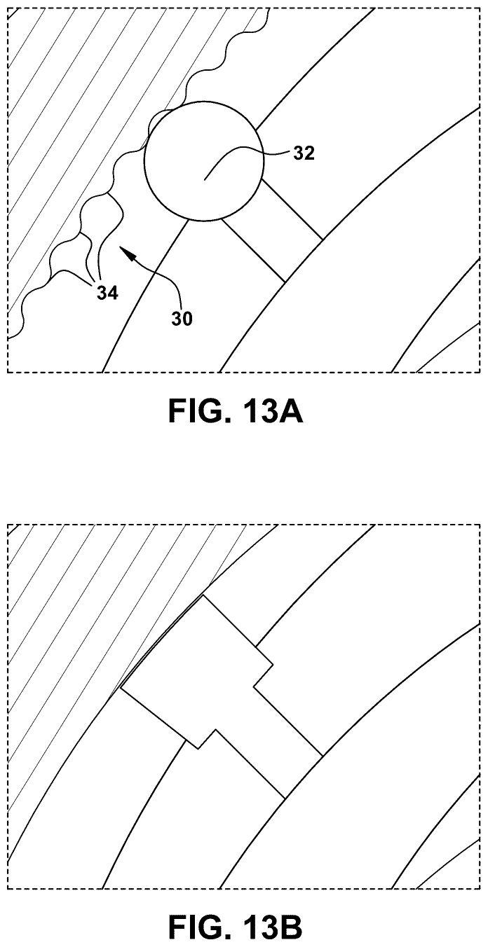

FIG. 12 shows the arms 20 near the limits of the smallest bottle neck that the arms 20 can clamp. FIG. 13A shows the humped cam surface against the cam follower/pawl 32. FIG. 13B presents an alternate friction version.

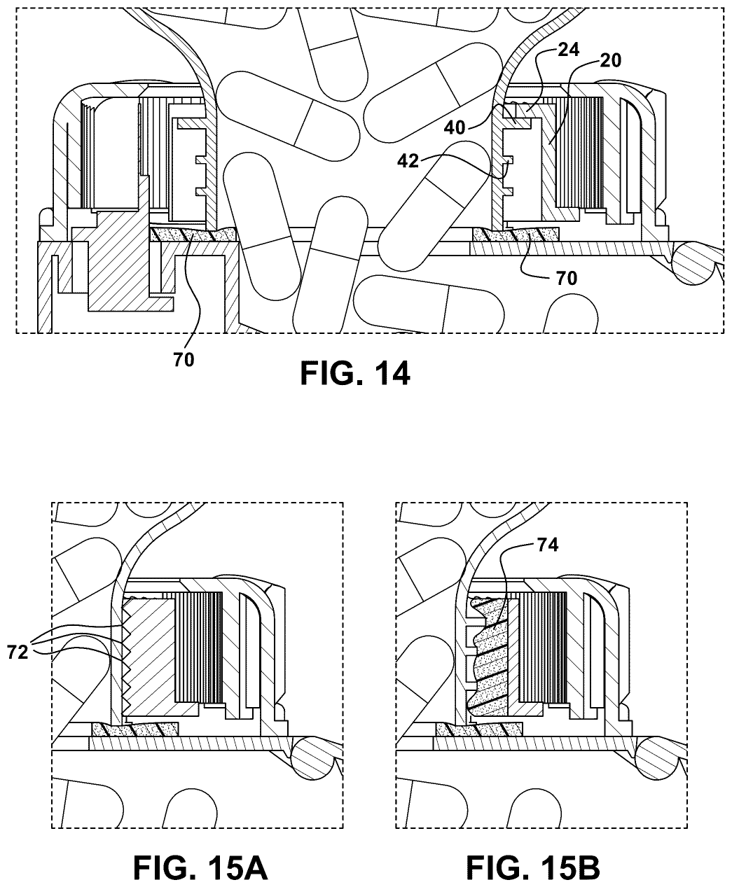

FIG. 14 depicts a seal attachment where seal 70 is attached to the top surface 11, which improves moisture resistance and can also serve to raise the bottle flange 40 closer to the arm ledges 24. The arm ledges help to press the bottle 12 downwardly against the seal 70 to aid in improving the air-tight nature of the design.

FIGS. 15A-15B show alternative versions of the clamping mechanism. In the embodiments shown in FIGS. 15A and 15B, grasping surfaces are provided by the clamping arm surfaces, such as extending points 72 or rubber padding 74, to suit various bottle designs and sizes. Additionally, the invention can accommodate different numbers of clamping arms (e.g., two, four, or more) depending on the application.

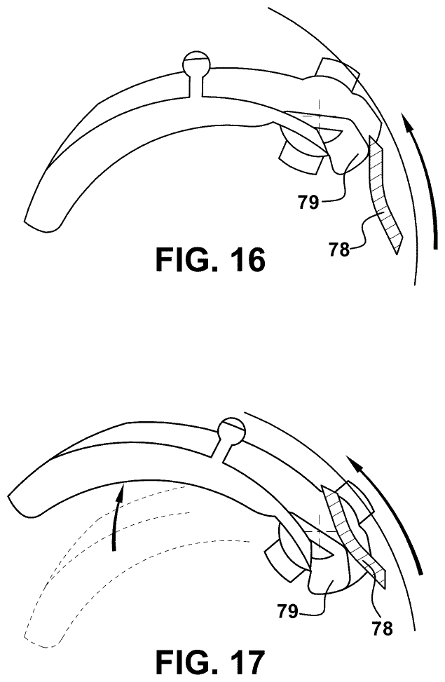

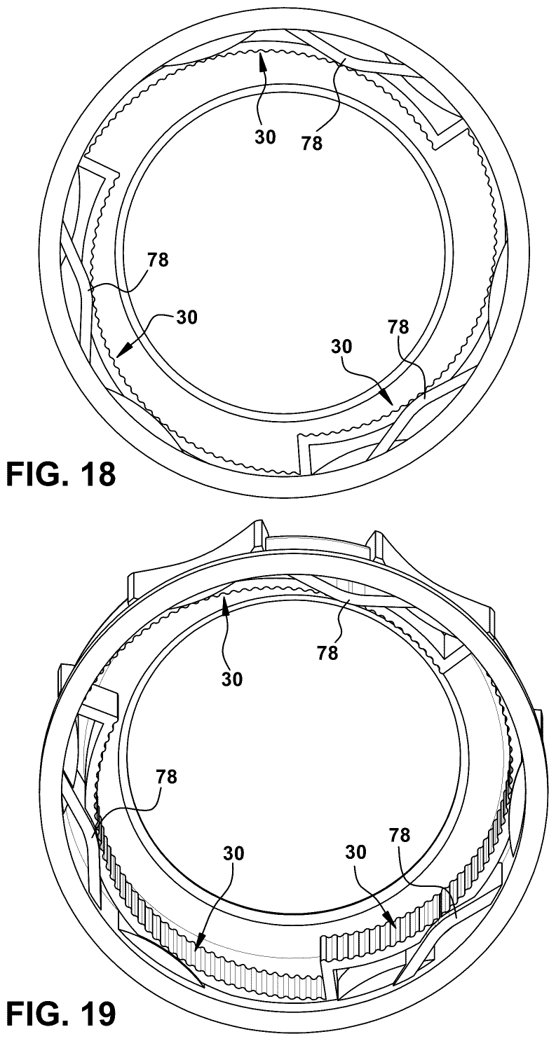

FIGS. 16-17 depict a retraction mechanism. When the dial 22 is rotated counter-clockwise, as shown in FIGS. 16 and 17, there are three small cams 78 on the dial (one associated with each arm) that interact with the extended portions 79 on each arm. This interaction retracts each arm into a bottle loading position. FIGS. 18 and 19 depicts bottom view and bottom perspective view, respectively, of the dial 22 showing the ratchet humps 30 and the cams 78.

As is evident, the ratchet bumps/humps are positioned on a ramp that extends from the outer wall of the dial 22 to an inner position that is spaced from the outer wall of the dial. The inner position represents the tightest position that the dial can achieve when a bottle is positioned inside the opening of the dial 22. The length of an arm experiences a flexing strain that maintains its cam follower between two bumps when locked. When tightening and the arm is flexing, the cam follower ratchets past each bump until a desired grasp of the bottle is reached. The bottle is held firmly for the life of the contents through all shocks to the bottle and dispenser. The surfaces of the ramps and cams 78 are made of a hard material that does not easily bend, such as a hard plastic material.

To loosen the pill bottle from dispenser base, an arm cam follower needs to clear only one of the ratcheting bumps because the arm is in a flexed state. This makes it easy to release a bottle from the dispenser.

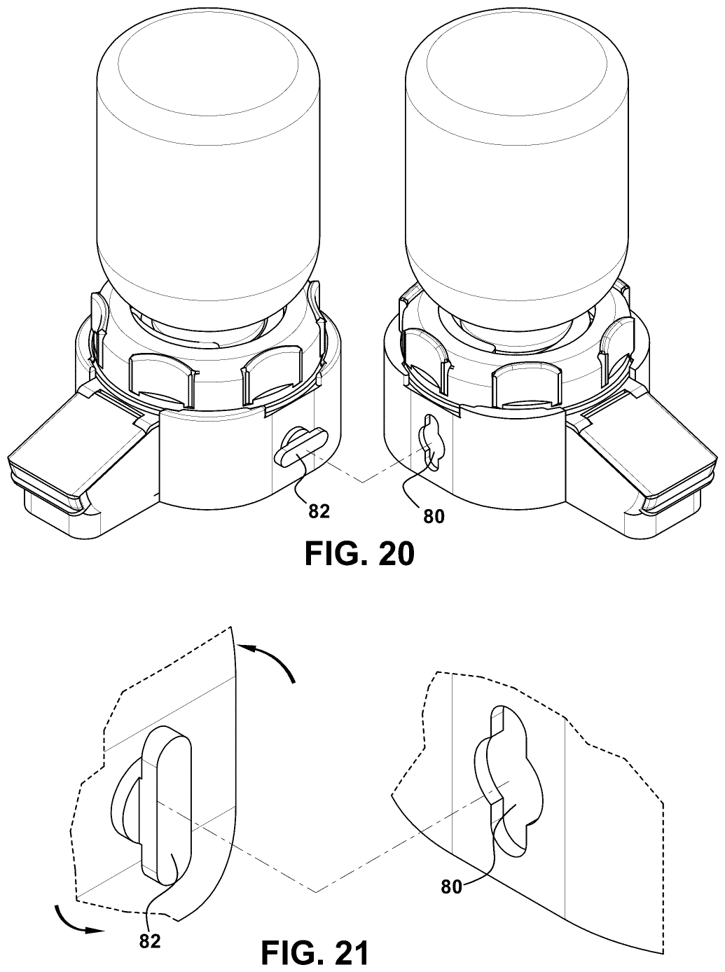

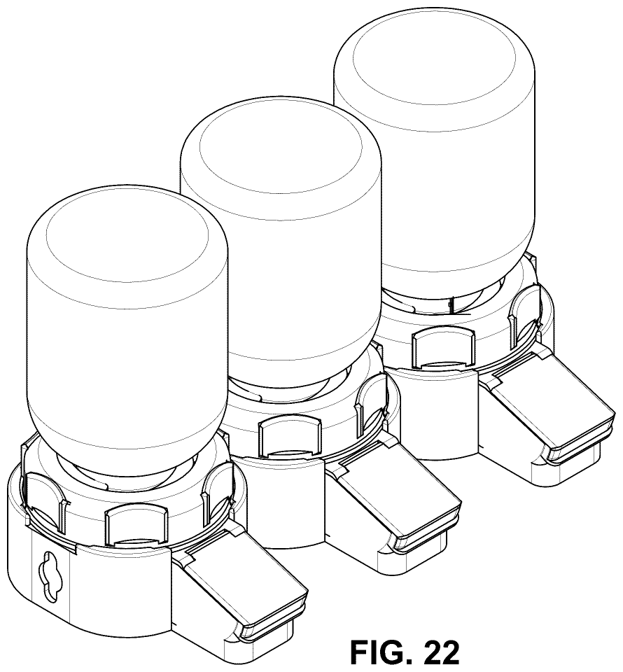

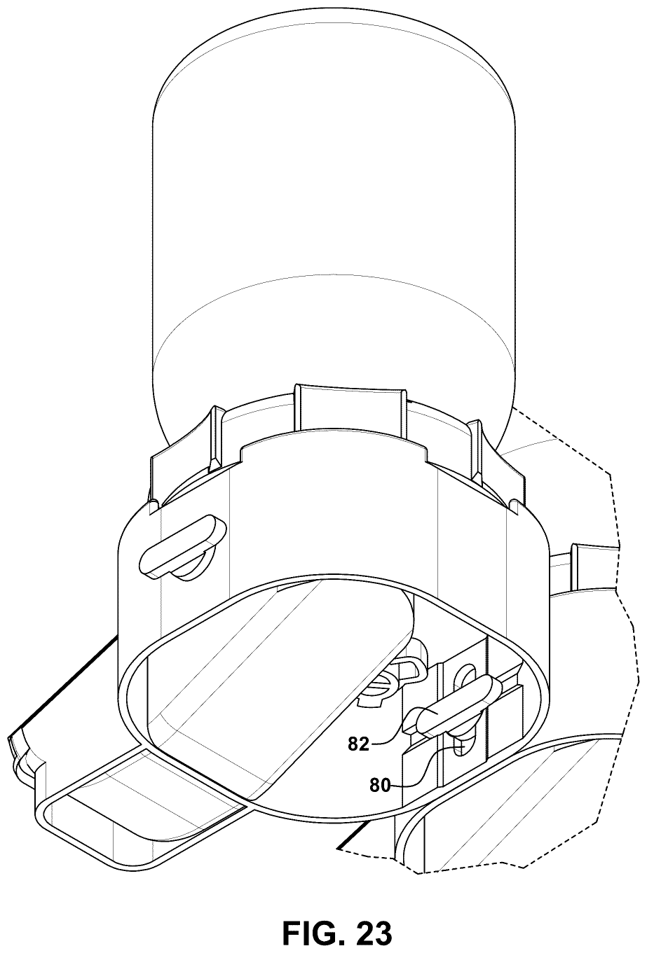

FIGS. 20-23 depicts a mechanism for grouping multiple bottles together. FIGS. 20-23 depict a female 80 opening on one side of the base 15 and a male 82 locking mechanism on the other side of the base 15. The two parts of the locking mechanism 80, 82 allow multiple dispensers 10 to be grouped together and, thus, multiple bottles 12 to be grouped together, enabling easy access to multiple pill types. This is one way to connect multiple bottles and can also be accomplished in many different ways including fastening clips, magnets, etc. By grouping together multiple pill bottles, one large dispenser unit can be created that can be lifted and moved from shelf or cabinet to counter and back without the individual dispensers falling apart.

Advantages of this design include an improvement in organization, added convenience, and modularity. The grouping mechanism allows users to organize their pills by grouping bottles according to the schedule of intake. For example, bottles can be grouped together for morning pills and separately for evening pills. The grouping of bottles together makes it easier to access multiple pills at once, reducing the likelihood of missing a dose and simplifying the daily pill-taking routine. In addition, the grouping mechanism is designed to be modular, allowing users to add or remove bottles as their needs change. This flexibility is particularly useful for those who take different medications on different schedules.

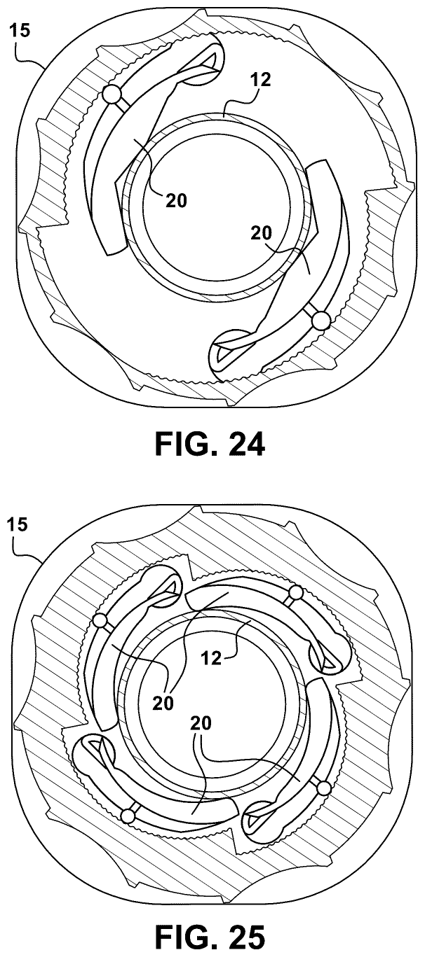

FIGS. 24-25 depict the versatility of the bottle locking/attachment mechanism. The bottle attachment mechanism can work with just two arms and also with four or more, demonstrating its versatility in accommodating different bottle sizes and configurations. FIG. 24 depicts two arms and FIG. 25 depicts four arms.

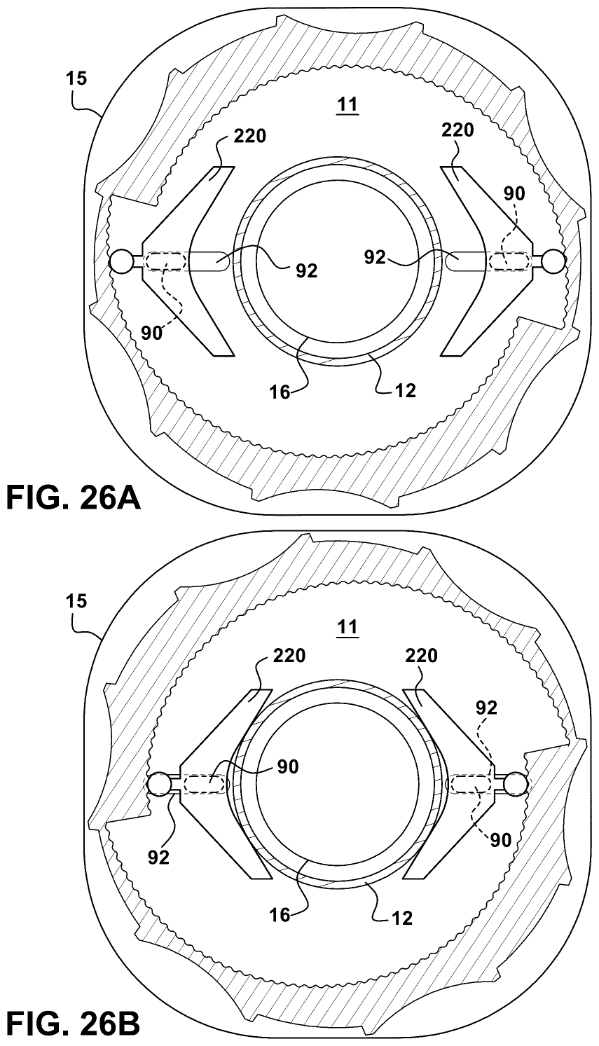

FIGS. 26A-26B depict an alternate clamping mechanism where there are two arms 220 that move linearly on attached posts 90. The posts 90 extend into slots 92 on the top surface 11 of the base 15. The slots 92 guide the posts 90 and arms 220 linearly left to right. The pawl 23 operates the same as in previous embodiments.

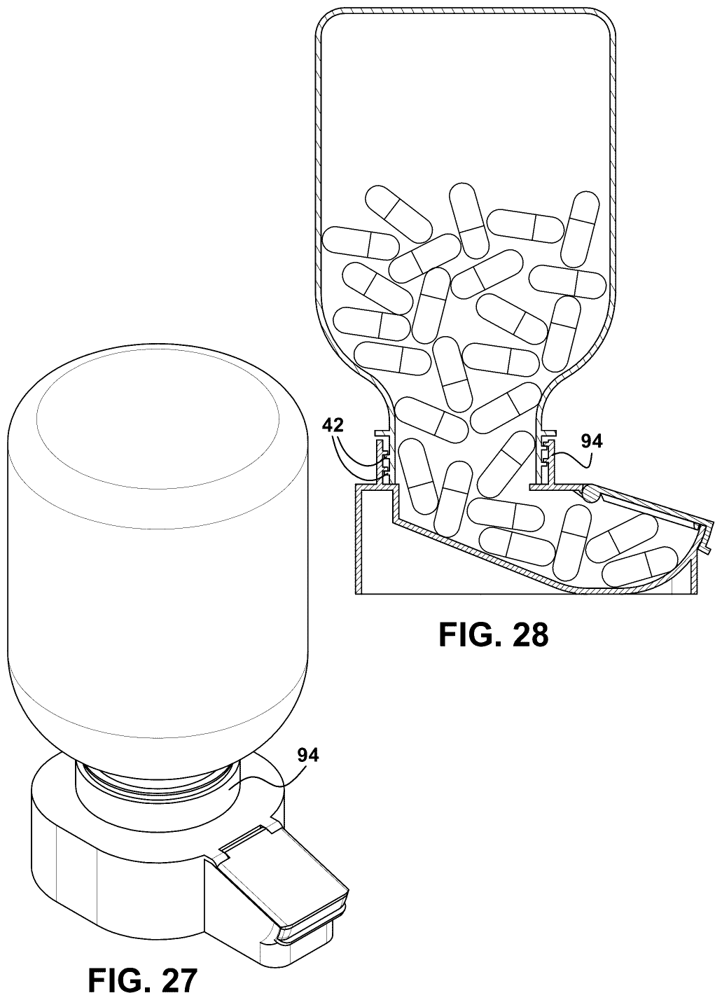

FIGS. 27-28 show an alternative embodiment where the attachment mechanism is a simple threaded or snap-on portion 94 that is made for a specific bottle not unlike the typical bottle cap. This can be produced by the bottle manufacturer to be included with the pills/product. The bottle is simply screwed into the dispenser. In this embodiment, the dispenser could serve as a cap for the bottle or could be provided in addition to the cap.

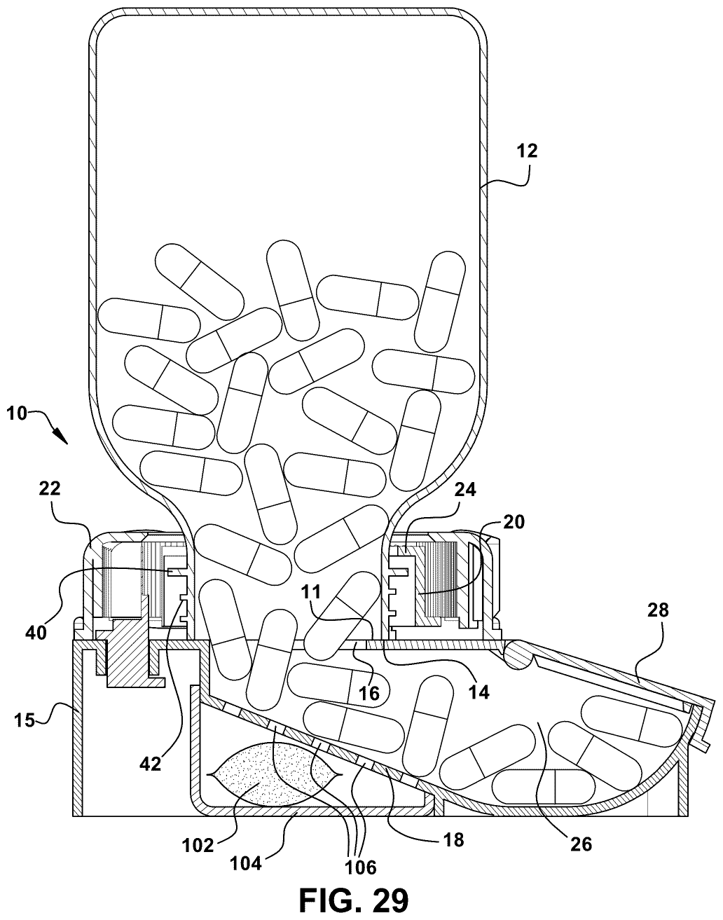

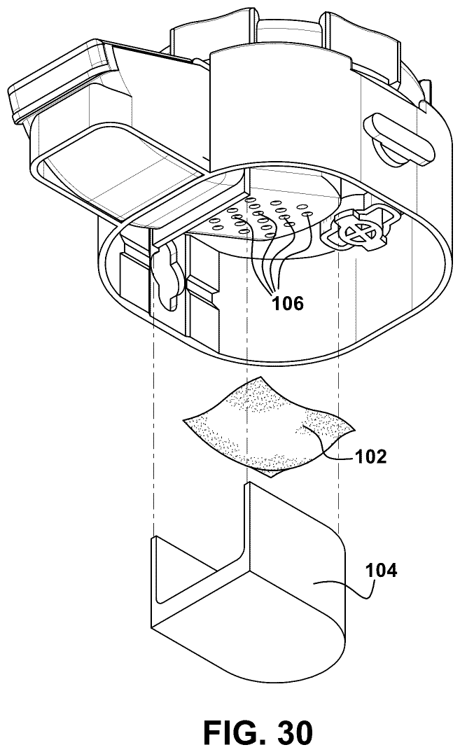

FIGS. 29-30 depicts a desiccant chamber enclosed within the base. A desiccant package 102 can be included by locating a closed detachable chamber 104 under the chute 18 which has holes 106 along the bottom wall. This assists in removing humidity from around the pills within the bottle 12, chute 18 and pill retrieval area 26.

The device may be made of injection molded plastic. In one embodiment, the base is 3″×4.5″ and has a height of 2.25″. The size of the base will be dependent upon the size of the bottle that is to be used with the device. While the drawings show a bottle having a neck, traditional prescription bottle may also be used with the invention. Any bottle having a flange may be used with the dispenser 10. Because the arms have ledges 24, the ledges prevent arms from passing over the flange and deters the bottle from sliding out of the dispenser 15. The ledges also grasp and contact the bottle. Bottles that lack a flange may also be used with the invention. In this case, the arms could have a rubber tip that grabs the bottle, instead of relying on the flange to hold the bottle down.

The pill dispenser offers an efficient and user-friendly method for accessing pills from bottles. Its design includes a secure, moisture-proof seal, one-handed access, and flexible customization options to accommodate different user needs. The pills stay with the bottle preventing misidentifying medication or supplements which can happen with pill dispensers where the pills are separated from the original bottle. Also, the pills can be accessed with one hand from a shelf or in a cabinet where the pills stay out of the reach of children. This invention enhances the convenience and safety of pill retrieval, making it a valuable solution for a wide range of applications.

According to the invention, a dispenser for pills includes a base member, a top surface, a coupling member, and a retrieval area. The base member is for seating on a surface and has a substantially centrally located through opening in the interior thereof, with a chute extending outwardly from the centrally located through opening. The top surface associated with the base member in communication with the through opening and the chute. The coupling member is attached to the base adjacent the top surface thereof and has a coupling mechanism positioned therein for mating with one end of a separate receptacle of varying sizes. The receptacle is for holding pills and has an open end. The retrieval area is coupled to an outer end of the chute. The retrieval area extends outwardly from the base and defines a trough. The coupling member is movable to tighten the receptacle inside the base member adjacent the top surface.

A door may be positioned over the retrieval area. A sealing member may be positioned between the top surface and the receptacle when the receptacle is installed on the top surface. The base may include a mechanism for joining the base to another base. The mechanism for joining is one or more of a mechanical fastener, a tape, or a magnet.

The coupling member may include a quick release mechanism for releasing the bottle from the dispenser. The coupling mechanism may include two or more arms that are pivotably attached within an interior of the coupling member to at least partially surround the through opening. The arms are movable inwardly and outwardly against the action of one or more cam surfaces positioned on the coupling member. Movement of the coupling member either moves the arms inwardly to a tightening position or moves the arms outwardly to a released position where the bottle can be removed from the coupling mechanism. The coupling mechanism may included multiple arms that are configured to grasp different diameter bottles. The bottle may have a ledge or screw threads adjacent the open end thereof and the arm has a ledge that interacts with the ledge of the bottle to hold the bottle in position in the coupling member.

One or more attachment means may be coupled to a side surface of the base for permitting the coupling together of multiple dispensers. The attachment means may comprise one or more of mechanical fasteners, tape, or magnets. Two or more dispensers may be provided and are coupled together using the attachment means.

One or more cam surface may include ratcheting bumps and the ratcheting bumps may be coupled to a cam follower that is attached to the arm. The arm experiences a flexing strain that maintains the cam follower between two bumps when locked. When the arm is locked, the bottle is held firmly inside the dispenser.

In another embodiment, a dispenser for dispensing contents includes a base member, means for directing items out of the base member, and a coupling member. The base member has a coupling member attached to a top surface thereof for coupling a receptacle to the base member. The receptacle has an opening in one end thereof for communicating with an opening in the base member. The means for directing items out of the base are coupled to the opening in the base member. The coupling member has a tightening member with arms that help to center the opening of the receptacle between the arms and lock the receptacle inside the base member.

The coupling member may include cam surfaces that interact with the arms to tighten the arms against the receptacle when the coupling member is rotated. The cam surfaces may include a plurality of bumps that interact with the arms to hold the arms in position once flexed against the receptacle. The cam surfaces may move with rotation of the coupling member to either tighten or loosen the coupling member relative to the receptacle.

In yet another embodiment, a dispenser for coupling to a bottle having a contents includes a base having an opening for receiving an end of a bottle. The base includes a chute coupled to the opening and a receiving tray for receiving contents from the bottle. After the bottle is opened and the base is installed over the open end of the bottle, the contents of the bottle are only removed through the chute.

The opening may include screw threads for coupling the end of the bottle to the opening in the base. The dispenser may further include a rotatable dial having arms that act against cam surfaces positioned on an inner surface of the dial. The arms interact with the end of the bottle to hold the bottle in position inside the dial.

The term “substantially,” if used herein, is a term of estimation.

While various features are presented above, it should be understood that the features may be used singly or in any combination thereof. Further, it should be understood that variations and modifications may occur to those skilled in the art to which the claimed examples pertain. The examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The scope of the disclosure is accordingly defined as set forth in the appended claims.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim. The term “consisting essentially,” if used herein, means the specified materials or steps and those that do not materially affect the basic and novel characteristics of the material or method. All percentages and averages are by weight unless the context indicates otherwise. If not specified above, the properties mentioned herein may be determined by applicable ASTM standards, or if an ASTM standard does not exist for the property, the most commonly used standard known by those of skill in the art may be used. The articles “a,” “an,” and “the,” should be interpreted to mean “one or more” unless the context indicates the contrary.

What is claimed is:

1. A dispenser for pills comprising:
a base member for seating on a surface and having a substantially centrally located through opening in the interior thereof, with a chute extending outwardly from the centrally located through opening;
a top surface associated with the base member in communication with the through opening and the chute;
a coupling member attached to the base member adjacent the top surface thereof and having a coupling mechanism positioned therein for mating with one end of a separate receptacle of varying sizes, said receptacle for holding pills and having an open end;
a retrieval area coupled to an outer end of the chute, said retrieval area extending outwardly from the base member and defining a trough;
wherein the coupling member is movable to tighten the receptacle inside the base member adjacent the top surface.

2. The dispenser of claim 1, wherein a door is positioned over the retrieval area.

3. The dispenser of claim 1, wherein a sealing member is positioned between the top surface and the receptacle when the receptacle is installed on the top surface.

4. The dispenser of claim 1, wherein the base member includes a mechanism for joining the base member to another base member and the mechanism for joining is one or more of a mechanical fastener, a tape, or a magnet.

5. The dispenser of claim 1, wherein the coupling member includes a quick release mechanism for releasing the bottle from the dispenser.

6. The dispenser of claim 1, wherein the coupling mechanism includes two or more arms that are pivotably attached within an interior of the coupling member to at least partially surround the through opening, with the arms movable inwardly and outwardly against the action of one or more cam surfaces positioned on the coupling member and movement of the coupling member either moves the arms inwardly to a tightening position or moves the arms outwardly to a released position where the bottle can be removed from the coupling mechanism.

7. The dispenser of claim 1, wherein the coupling mechanism comprises multiple arms that are configured to grasp different diameter bottles.

8. The dispenser of claim 7, wherein the bottle has a ledge or screw threads adjacent the open end thereof and the arm has a ledge that interacts with the ledge or screw threads of the bottle to hold the bottle in position in the coupling member.

9. The dispenser of claim 1, further comprising one or more attachment means coupled to a side surface of the base member for permitting the coupling together of multiple dispensers, wherein the attachment means comprises one or more of mechanical fasteners, tape, or magnets.

10. The dispenser of claim 9, wherein two or more dispensers are provided and are coupled together using the attachment means.

11. The dispenser of claim 6, where the one or more cam surfaces include ratcheting bumps and the ratcheting bumps are coupled to a cam follower that is attached to the arm, and the arm experiences a flexing strain that maintains the cam follower between two bumps when locked.

12. The dispenser of claim 11, wherein when the arm is locked, the bottle is held firmly inside the dispenser.

13. A dispenser for dispensing contents comprising:
a base member having a coupling member attached to a top surface thereof for coupling a receptacle to the base member, with the receptacle having an opening in one end thereof for communicating with an opening in the base member;
means for directing items out of the base member coupled to the opening in the base member;
the coupling member having a tightening member with arms that help to center the opening of the receptacle between the arms and lock the receptacle inside the base member.

14. The dispenser of claim 13, wherein the coupling member includes cam surfaces that interact with the arms to tighten the arms against the receptacle when the coupling member is rotated.

15. The dispenser of claim 14, wherein the cam surfaces include a plurality of bumps that interact with the arms to hold the arms in position once flexed against the receptacle.

16. The dispenser of claim 14, wherein the cam surfaces move with rotation of the coupling member to either tighten or loosen the coupling member relative to the receptacle.

17. A dispenser for coupling to a bottle having a contents comprising:
a base having an opening for receiving an end of a bottle, said base including a chute coupled to the opening and a receiving tray for receiving contents from the bottle, wherein after the bottle is opened and the base is installed over the open end of the bottle, the contents of the bottle are only removed through the chute.

18. The dispenser of claim 17, wherein the opening includes screw threads for coupling the end of the bottle to the opening in the base.

19. The dispenser of claim 17, wherein the dispenser further comprises a rotatable dial having arms that act against cam surfaces positioned on an inner surface of the dial, wherein the arms interact with the end of the bottle to hold the bottle in position inside the dial.
